(19) United States
(12) Patent Application Publication
(10) Pub. No.: US 2010/0279656 A1
(43) Pub. Date: Nov. 4, 2010

(54) SYSTEMS AND METHODS FOR CORRELATING MULTIPLE LOCATION SOURCES

(75) Inventor: Gideon Hazzani, Rishon Le Zion (IL)

Correspondence Address: Lawrence A. Aaronson, P.C.;Lawrence A. Aaronson, 12850 Highway 9, Suite #600 PMB 338, Alpharetta, GA, 30004, US

(73) Assignee: VERINT SYSTEMS LTD., Herzliya Pituach (IL)

(21) Appl. No.: 12/608,474

(22) Filed: Oct. 29, 2009

(30) Foreign Application Priority Data
Dec. 25, 2008 (IL) 195506

(51) Int. Cl. H04M 1/66; H04W 24/00; H04W 4/02; G06Q 20/00

(52) U.S. Cl. 455/411; 455/456.5; 370/328; 705/21

(57) ABSTRACT

A system and method for correlating multiple location sources of mobile users. The method includes accepting a first location of a user from a first system, accepting a second location of the user from a second system and processing the first and second location so as to detect a violation of a predefined rule specifying a legitimate relationship between the first and second locations. An action with respect to the detected violation may then be invoked.

### FIELD OF THE DISCLOSURE

The present disclosure relates generally to location tracking, and particularly to methods and systems for correlating multiple location indications of users of wireless communication terminals.

### BACKGROUND OF THE DISCLOSURE

Mobile communication networks deploy various techniques for measuring the geographical locations of wireless communication terminals. Such techniques are used, for example, for providing Location Based Services (LBS) and emergency services in cellular networks. Some location tracking techniques are based on passive probing of network events generated by the wireless terminals. Other techniques are active, i.e., proactively request the network or the terminal to provide location information.

### SUMMARY OF THE DISCLOSURE

An implementation that is described herein provides a method, including:

accepting a first location indication regarding a first location of a user from a first system;

accepting a second location indication regarding a second location of the user from a second system, different from the first system;

processing the first and second location indications so as to detect a violation of a predefined rule specifying a legitimate relationship between the first and second locations; and

invoking an action with respect to the detected violation.

In some implementations, the user communicates with a wireless communication network using a wireless communication terminal, and accepting the first location indication includes receiving from the wireless communication network location information regarding the wireless communication terminal. In an implementation, accepting the second location indication includes accepting other location information of another wireless communication terminal that is associated with the user.

Accepting the second location indication may include accepting a notification of a Point-of-Sale (POS) transaction conducted by the user at the second location. Additionally or alternatively, accepting the second location indication may include accepting a notification of a communication session conducted by the user using another communication terminal, which is located at the second location, and another communication network.

In an implementation, the other communication terminal has an Internet Protocol (IP) address that is associated with the user, and accepting the second location indication includes accepting a notification of a communication session conducted with the IP address. In another implementation, accepting the second location indication includes accepting a notification of a communication session conducted with a fixed telephone terminal that is associated with the user.

In a disclosed implementation, accepting the second location indication includes accepting an authentication of an identity of the user that was verified by the second system. Invoking the action may include triggering an alert to an operator responsively to the detected violation. In an implementation, accepting the second location indication includes accepting other location information of another wireless communication terminal that is associated with the user.

In a disclosed implementation, the rule specifies a maximum permitted distance between the first and second locations. Additionally or alternatively, the rule may specify a legitimate difference between respective first and second times at which the first and second locations were measured.

There is additionally provided, in accordance with an implementation that is described herein, apparatus, including:

an interface, which is operative to accept a first location indication regarding a first location of a user from a first system, and to further accept a second location indication regarding a second location of the user from a second system, different from the first system; and

a processor, which is coupled to process the first and second location indications so as to detect a violation of a predefined rule specifying a legitimate relationship between the first and second locations, and to invoke an action with respect to the detected violation.

The present disclosure will be more fully understood from the following detailed description of the implementations thereof, taken together with the drawings in which:

### BRIEF DESCRIPTION OF THE DRAWINGS

FIG. 1 is a schematic, pictorial illustration of a system for correlating multiple location sources of mobile users, in accordance with an implementation of the present disclosure;

FIG. 2 is a block diagram that schematically illustrates a system for correlating multiple location sources of mobile users, in accordance with an implementation of the present disclosure; and

FIG. 3 is a flow chart that schematically illustrates a method for correlating multiple location sources of mobile users, in accordance with an implementation of the present disclosure.

### DETAILED DESCRIPTION OF IMPLEMENTATIONS

### Overview

Various systems and applications, such as surveillance systems operated by government and law enforcement agencies, track the locations of wireless communication terminals (e.g., cellular phones). Typically, the mobile terminal is tracked not for its own sake but as a means to track the user, i.e., the individual associated with the terminal.

In some cases, however, the location of the wireless terminal does not reflect the true location of its user. For example, a target user may replace his or her terminal's Subscriber Identity Module (SIM) from time to time in order to evade surveillance. Thus, it is important to detect scenarios in which the location of the wireless terminal is different from the location of the user associated with the terminal.

Implementations that are described herein provide improved methods and systems for tracking the locations of users of wireless communication terminals. In some implementations, a monitoring center receives information regarding the location of a wireless communication terminal that is associated with a given user from a wireless communication network with which the terminal communicates. In addition, the monitoring center receives a location indication regarding the location of the user from another source of location data.

For example, the location indication may comprise a notification of an Automatic Teller Machine (ATM) or Point-Of-Sale (POS) transaction, which was conducted using a credit or ATM card that is associated with the user in question. A mismatch between the location information (of the terminal) accepted from the wireless communication network and the location indication (of the user) accepted from the other source of location data may indicate a suspicious scenario, especially when the two occur at approximately the same time. Upon detecting a suspicious scenario, the monitoring center triggers an alert or invokes other appropriate action.

Several additional examples of location data sources that indicate the location of the user are described herein. These location data sources can be used additionally or alternatively to ATM or POS transactions. The methods and systems described herein can be used with various types of wireless communication networks and location tracking techniques. In some implementations, the other source of location data verifies the identity of the user in addition to indicating the user's location, in order to reduce the likelihood of false alerts.

The correlation methods described herein are highly efficient in detecting suspicious scenarios in which users attempt to deceive the location tracking system. As such, the disclosed methods and systems considerably improve the reliability of location tracking systems.

In alternative implementations, the correlation methods described herein operate on location indications received from different systems, such as ATM/POS systems, surveillance cameras, etc., which do not necessarily involve any sort of wireless communication. Thus, the methods and systems described herein can also be used with individuals that do not carry or operate wireless communication terminals.

### System Description

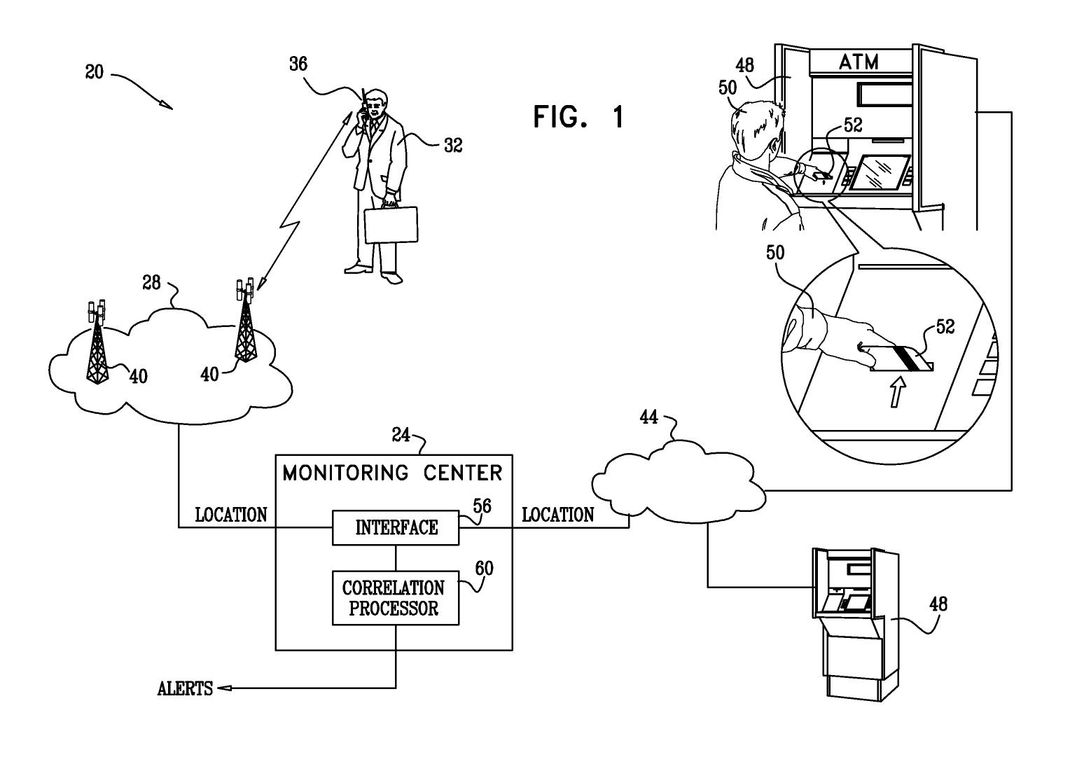

FIG. 1 is a schematic, pictorial illustration of a system 20 for correlating multiple location sources of mobile users, in accordance with an implementation of the present disclosure. In system 20, users 32 of mobile communication terminals 36 communicate with a wireless communication network 28 via base stations 40.

System 20 tracks the locations of users 32. The system can be used, for example, by a government or law enforcement agency to track mobile communication terminals (e.g., cellular phones) that are operated by individuals under surveillance. System 20 comprises a monitoring center 24, which is connected to wireless network 28. Network 28 measures the locations of terminals 36 and provides the monitoring center with information regarding the measured locations.

In some cases, however, the location of a given mobile terminal does not reflect the true location of its user. Many location tracking applications are interested in tracking the user associated with the terminal, and the location of the mobile terminal is used only as a means for locating the user. It is therefore important to detect scenarios in which a certain terminal is located at one location, but the user associated with the terminal is located at a different location.

Such a scenario may indicate, for example, that the user has replaced his cellular phone or Subscriber Identity Module (SIM) in order to evade surveillance. (A terminal whose SIM has been replaced retains its International Mobile Equipment Identity (IMEI). Nevertheless, the terminal cannot usually be tracked using this identifier, since it is typically transmitted only once, on the first power-up registration of the terminal after replacing the SIM. Thus, tracking is usually based on the International Mobile Subscriber Identity (IMSI), which changes when the SIM is replaced.)

In order to identify scenarios in which a terminal and its user are not at the same location, monitoring center 24 receives location indications regarding the user from other location data sources. In the present example, the monitoring center receives indications of Automatic Teller Machine (ATM) transactions performed by individuals 50 at ATMs 48 using ATM cards 52. For this purpose, the monitoring center is connected to a network 44 of an ATM operator. Since the geographical locations of ATMs 48 are known, an ATM transaction performed by a certain ATM card 52 provides an indication as to the location of the owner of this card.

Both the location tracking information provided by wireless network 28 and the location indications provided by ATM network 44 are time-stamped. Therefore, by correlating the information received from the two location data sources, the monitoring center can identify a situation in which mobile terminal 36 is at one location, while ATM card 52 of the user associated with the terminal is at a different location. Such a situation is typically regarded as suspicious, since the terminal and the ATM card are associated with the same individual and are therefore expected to be collocated. When identifying a suspicious situation in which the location of the terminal does not match other location indications of the user, the monitoring center triggers an alert or invokes other action.

The description above refers to a single user, a single mobile terminal and a single ATM card, for the sake of conceptual clarity. In alternative implementations, system 20 can correlate location information and indication regarding multiple users, mobile terminals and ATM cards. The system may operate in a target-centric manner, in which the monitoring center selectively tracks a pre-specified subset of target users. Additionally or alternatively, the system may operate in a data-centric manner, in which the monitoring center does not mark users as targets a-priori, but rather tracks the users of network 28 non-selectively.

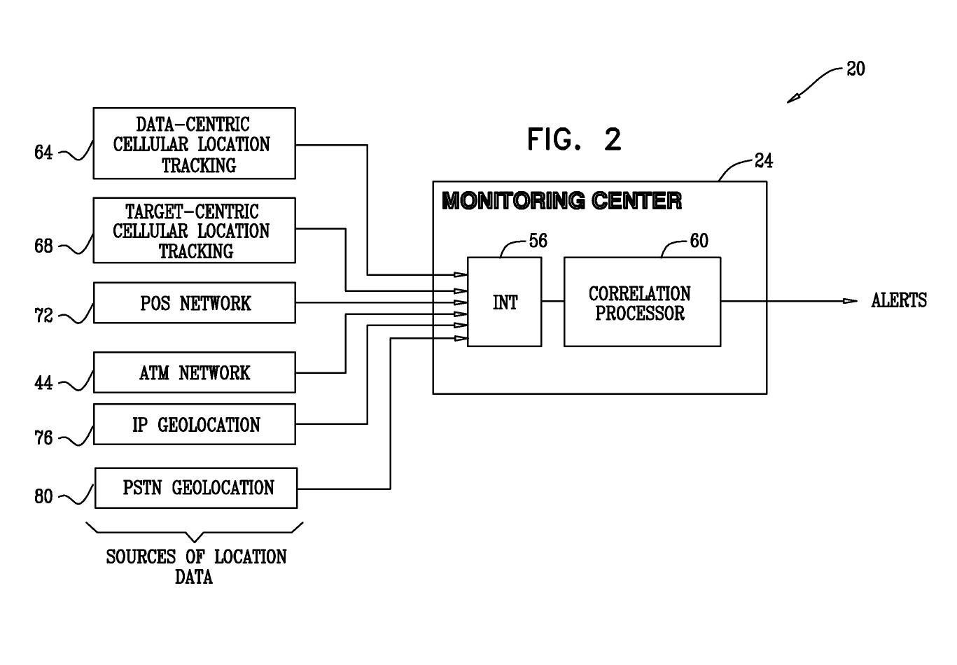

The implementation of FIG. 1 presents a system that obtains location indications of users from ATM transactions. This implementation is shown, however, purely by way of example. In alternative implementations, system 20 may receive location indications from a large variety of location data sources, which provide various kinds of indications regarding user locations. Several examples of location data sources that can be used by system 20 are described in FIG. 2 below.

Terminals 36 may comprise, for example, cellular phones, wireless-enabled Personal Digital Assistants (PDA) or mobile computers, or any other suitable type of communication or computing terminal having wireless communication capabilities.

Network 28 may comprise any suitable wireless communication network. The network may comprise, for example, a cellular network operating in accordance with any suitable cellular standard or protocol, such as a Universal Mobile Telecommunication System (UMTS) network, CDMA2000 network or other third generation (3G) cellular network, a Global System for Mobile communication (GSM) network or an Integrated Digital Enhanced Network (IDEN) network. Alternatively, network 28 may comprise a WiMAX network operating in accordance with the IEEE 802.16 standards or other wireless data network.

Network 28 may use a variety of location tracking techniques for tracking the locations of terminals 36. Some location tracking techniques, referred to as network-based techniques, are carried out by the base stations and other network-side components of network 28, without necessarily using special hardware or software at the mobile terminal side. For example, Cell Identification (CID) techniques, also sometimes referred to as Cell Global Identity (CGI) techniques, locate the user by identifying the cell via which the user currently communicates. Enhanced CID (E-CID, also referred to as E-CGI) techniques combine CID information with timing information, which is indicative of the distance between the user and the base station. In UMTS networks, for example, the timing information may comprise Round-Trip Time (RTT) values. In GSM applications, timing information may comprise Time Advance (TA) values.

Another network-based location technique, called Uplink Time Difference of Arrival (U-TDOA), determines the user position by comparing and calculating the difference in time required for a user transmission to reach different base station sites. The arrival time measurements are made by Location Measurement Units (LMUs) installed at selected base station sites. Yet another technique, referred to as Angle of Arrival (AOA), determines the user position by establishing lines of bearing from base station sites to the user.

Other location tracking techniques are terminal-based, i.e., use special hardware or software in the mobile terminal. For example, some techniques use measurements performed by a Global Positioning System (GPS) receiver installed in the communication terminal.

In Assisted GPS (A-GPS) techniques, the GPS measurements are assisted by an assistance server external to the mobile terminal. The assistance server is sometimes equipped with another GPS receiver, whose position is known a-priori. Another terminal-based technique is Enhanced Observed Time Difference (E-OTD), in which the terminal measures the time differences between signal arrivals from different base stations. A similar terminal-based technique is called Enhanced Forward Link Trilateration (EFLT).

The location tracking techniques deployed in network 28 may be passive or active. Passive techniques perform unobtrusive probing of the signaling information transmitted in network 28, and extract location information from the monitored signaling. Active techniques, on the other hand, proactively request the network or the terminal to provide location information.

Monitoring center 24 can generate any suitable kind of alert upon detecting a suspicious scenario. For example, the monitoring center can present an alert message to an operator using a display or other output device. Additionally, the alert can be sent in a communication message such as using Short Message Service (SMS) or electronic mail.

Monitoring center 24 comprises an interface 56 for communicating with wireless network 28 and with the other location data sources, e.g., ATM network 44. The monitoring center further comprises a correlation processor 60, which carries out the location correlation and alerting methods described herein. Typically, processor 60 comprises a general-purpose computer, which is programmed in software to carry out the functions described herein. The software may be downloaded to the computer in electronic form, over a network, for example, or it may, alternatively or additionally, be provided and/or stored on tangible media, such as magnetic, optical, or electronic memory. In some implementations, processor 60 is separate from the monitoring center and is located in a suitable back-end system, such as on a suitable application server.

FIG. 2 is a block diagram that schematically illustrates system 20, in accordance with an implementation of the present disclosure. The figure shows several examples of location data sources that can be used by monitoring center 24. In network 28, location data sources may comprise a data-centric cellular location system 64 (e.g., a passive probing system) or a target-centric cellular location tracking system 68 (e.g., an active system such as U-TDOA).

Some location data sources are external to network 28. Such location data sources may comprise, for example, a Point-Of-Sale (POS) network 72 that processes credit-card transactions or other financial transactions associated with the user that are performed at a given time at a given POS location. Typically, a POS transaction (such as a credit-card purchase) is performed at a known location (e.g., cash register or credit card terminal) at a given time using a credit card that is associated with a known individual. Therefore, the record of such a transaction can be used as an indication of the individual's location at a given time. The monitoring center may be connected with POS, credit card or ATM systems using a communication interface, which specifies the transfer of relevant data (e.g., transaction time, transaction location and user identity).

In some implementations, monitoring center 24 may receive location indications from an Internet Protocol (IP) geolocation system 76, which provides the geographical location of a given IP address. IP geolocation services can be obtained from various providers, such as Internet service Providers (ISPs) or IP communication providers (e.g., Voice over IP operators). A user of interest may be associated with a certain IP address (e.g., the address of his or her IP phone or home computer). The IP address may be allocated on a dynamic basis or on a fixed basis. In either case, when a new connection is set up with a service provider (e.g., Internet service provider or mobile network operator), a time stamp is generated. The time stamp can be used to indicate the time at which the IP address in session was active. A mismatch between the location of this IP address and the measured location of the user's mobile terminal may indicate a suspicious scenario, especially if the two are active at approximately the same time.

As yet another example, the monitoring center may receive location indications from a Public Switched Telephone Network (PSTN) geolocation system 80. For example, a user of interest may be associated with a given fixed telephone having a known geographical location. The monitoring center may receive call records or other indications of activity of this telephone. These indications typically comprise time stamps, so that the activity of the user's telephone number can be pinpointed to a specific time and location. The monitoring center may declare a suspicious scenario if, for example, a call is held from the user's fixed telephone at a given time, but the user's mobile terminal is found to be at a different location at this time.

When using either IP or PSTN geolocation, the identity of the individual using the telephone can be verified using suitable speech processing techniques. Various speaker recognition techniques are known in the art, and any such technique can be used for this purpose. In these implementations, the source of location data (e.g., IP or PSTN geolocation system) comprises a suitable speaker verification module. A notification as to the success or failure to recognize the speaker can be provided to the monitoring center by the source of location data along with the corresponding location indication. Speaker recognition techniques may assist in reducing false alarms, e.g., avoiding a situation in which an individual other than the user of interest uses the IP/PSTN phone in question and triggers a false alert.

For reducing the likelihood of false alerts, IP geolocation techniques can be complemented by other interception techniques that verify the identity of the individual using the IP address in question. Such complementary techniques typically identify the user by intercepting certain communication sessions, which have identifiers that can be associated with the user. For example, the identity of the individual using the IP address can be verified using e-mail interception, instant messaging interception, or interception of any other suitable IP-based application in which the user identifies (e.g., logs in) using a unique identifier (e.g., username, password, mail account or nickname).

As another example of a source of location data, the monitoring center may receive location indications from another wireless communication network. For example, a certain user may own two wireless terminals, one operating in network 28 and another operating in another wireless network. The monitoring center may receive information from the other wireless network regarding the location of the other mobile terminal owned by the user.

Some location data sources may be internal to network 28. For example, in addition to the mobile terminal in question, the user of interest may own another cellular phone that is installed in his car and has a separate SIM. A mismatch between the locations of the two phones when the user's car phone is active may indicate a suspicious scenario.

Further additionally or alternatively, the monitoring center may receive any other suitable type of location indication from any suitable source of location data. In some implementations, the monitoring center processes location indications from multiple different location data sources in addition to the location measurements performed in network 28.

Correlation processor 60 may receive the location measurements from network 28 and the location indications from the other location data sources either in real time or off-line. Comparison between the location measurements and the location indications can also be performed in real time or off-line.

In some implementations, correlation processor 60 in the monitoring center detects a mismatch between the location measurements of the mobile terminal and the location indications received from other location data sources by evaluating one or more predefined rules. The rules specify legitimate or illegitimate relationships between the measured location of a mobile terminal and the location indications of the user associated with the terminal. For example, the rules may specify a time interval in which the location measurements and location indications should fall in order to qualify as a mismatch. In other words, the correlation processor may regard different locations of the user and his phone as a mismatch only if the two locations were measured within a certain predefined time interval.

As another example, the rules may specify the maximum permitted geographical distance between the mobile terminal (as measured by network 28) and the user (as indicated by the other location indications). Such a rule can be effective, for example, in IP geolocation applications in which the location indications are often rough. Additionally or alternatively, the rules may specify any other legitimate or illegitimate relationship between the measured location of a mobile terminal and the location indications of the user associated with the terminal.

### Correlation Method Description

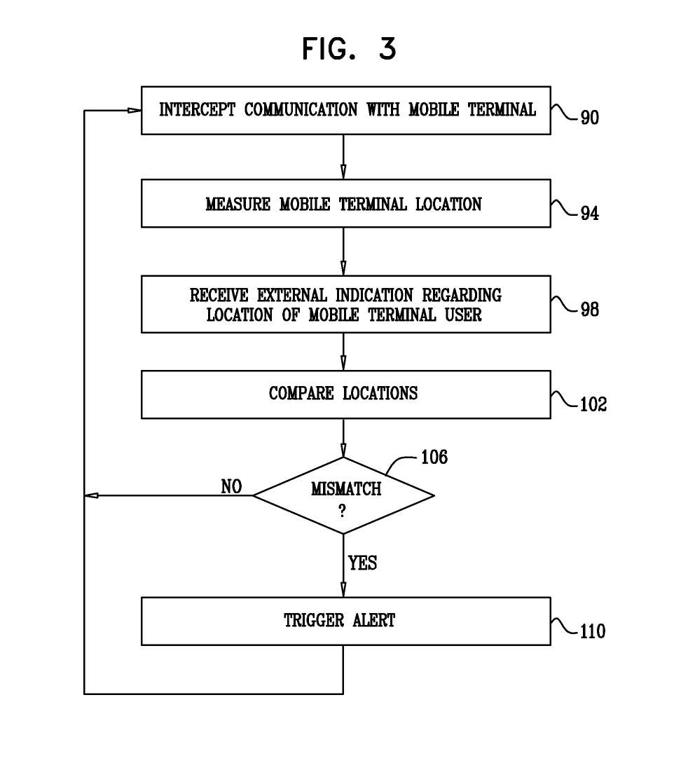

FIG. 3 is a flow chart that schematically illustrates a method for correlating multiple location sources of mobile users, in accordance with an implementation of the present disclosure. The method begins with system 20 intercepting communication between a given mobile terminal 36 and network 28, at an interception step 90. Elements of network 28 measure the location of terminal 36 using the intercepted communication, at a terminal location calculation step 94. The location information is provided to monitoring center 24.

Monitoring center 24 also receives indications regarding the location of the user associated with terminal 36 from one or more other location data sources, at a user location indication step 98. Correlation processor 60 in the monitoring center compares the location information regarding the terminal and the location indications regarding the user, at a comparison step 102.

The correlation processor checks whether the location information regarding the terminal matches the location indications regarding the user, at a checking step 106. Typically, the correlation processor evaluates one or more rules that define the legitimate or illegitimate relationship between the location measurements and location indications, and declares a match or mismatch based on these rule.

If a mismatch is detected, the monitoring center invokes appropriate action, such as triggering an alert. The method then loops back to step 90, and the system continues to intercept communication, receive location indications and check for suspicious mismatch situations.

### Tracking Individuals Irrespective of Wireless Communication Terminals

In some implementations, monitoring center 24 correlates multiple location indications regarding a given individual, which are accepted from two or more different systems, even if the individual does not carry or operate a wireless communication terminal. Such methods are useful, for example, for tracking individuals that intentionally refrain from using wireless communication in order to evade surveillance.

For example, correlation processor 60 in monitoring center 24 can correlate location indications regarding a given user that are accepted from systems such as an ATM/POS system, a video surveillance system and/or an automatic toll collection system that automatically identifies the individual's vehicle. When these multiple location indications violate a certain permitted relationship, the correlation processor invokes appropriate action, such as by triggering an alert.

Although the implementations described herein mainly address surveillance applications, the principles of the present disclosure can also be used for other applications, such as in network optimization.

It will thus be appreciated that the implementations described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. A method, comprising:
accepting a first location indication regarding a first location of a user from a first system;
accepting a second location indication regarding a second location of the user from a second system, different from the first system;
processing the first and second location indications so as to detect a violation of a predefined rule specifying a legitimate relationship between the first and second locations; and
invoking an action with respect to the detected violation.

2. The method according to claim 1, wherein the user communicates with a wireless communication network using a wireless communication terminal, and wherein accepting the first location indication comprises receiving from the wireless communication network location information regarding the wireless communication terminal.

3. The method according to claim 2, wherein accepting the second location indication comprises accepting other location information of another wireless communication terminal that is associated with the user.

4. The method according to claim 2, wherein accepting the second location indication comprises accepting a notification of a Point-of-Sale (POS) transaction conducted by the user at the second location.

5. The method according to claim 2, wherein accepting the second location indication comprises accepting a notification of a communication session conducted by the user using another communication terminal, which is located at the second location, and another communication network.

6. The method according to claim 5, wherein the other communication terminal has an Internet Protocol (IP) address that is associated with the user, and wherein accepting the second location indication comprises accepting a notification of a communication session conducted with the IP address.

7. The method according to claim 5, wherein accepting the second location indication comprises accepting a notification of a communication session conducted with a fixed telephone terminal that is associated with the user.

8. The method according to claim 2, wherein accepting the second location indication comprises accepting an authentication of an identity of the user that was verified by the second system.

9. The method according to claim 1, wherein invoking the action comprises triggering an alert to an operator responsively to the detected violation.

10. The method according to claim 1, wherein the rule specifies a maximum permitted distance between the first and second locations.

11. The method according to claim 1, wherein the rule specifies a legitimate difference between respective first and second times at which the first and second locations were measured.

12. Apparatus, comprising:
an interface, which is operative to accept a first location indication regarding a first location of a user from a first system, and to further accept a second location indication regarding a second location of the user from a second system, different from the first system; and
a processor, which is coupled to process the first and second location indications so as to detect a violation of a predefined rule specifying a legitimate relationship between the first and second locations, and to invoke an action with respect to the detected violation.

13. The apparatus according to claim 12, wherein the user communicates with a wireless communication network using a wireless communication terminal, and wherein the interface is coupled to accept the first location indication by receiving from the wireless communication network location information regarding the wireless communication terminal.

14. The apparatus according to claim 13, wherein the second location indication comprises other location information of another wireless communication terminal that is associated with the user.

15. The apparatus according to claim 12, wherein the second location indication comprises a notification of a Point-of-Sale (POS) transaction conducted by the user at the second location.

16. The apparatus according to claim 12, wherein the second location indication comprises a notification of a communication session conducted by the user using another communication terminal, which is located at the second location, and another communication network.

17. The apparatus according to claim 16, wherein the other communication terminal has an Internet Protocol (IP) address that is associated with the user, and wherein the second location indication comprises a notification of a communication session conducted with the IP address.

18. The apparatus according to claim 12, wherein the second location indication further indicates an authentication of an identity of the user that was verified by the second system.

19. The apparatus according to claim 12, wherein the processor is coupled to trigger an alert to an operator responsively to the detected violation.

20. The apparatus according to claim 12, wherein the rule specifies a maximum permitted distance between the first and second locations.
